(19) United States
(12) Patent Application Publication
(10) Pub. No.: US 2026/0028155 A1
(43) Pub. Date: Jan. 29, 2026

(54) Two-Layer Can Strip Coating

(71) Applicants: Petra Karbach-Parr, Grevenbroich (DE); Stefan Schlüter, Düsseldorf (DE); Antonio Mateo, Grevenbroich (DE)

(72) Inventors: Petra Karbach-Parr, Grevenbroich (DE); Stefan Schlüter, Düsseldorf (DE); Antonio Mateo, Grevenbroich (DE)

(73) Assignee: Speira GmbH, Grevenbroich (DE)

(21) Appl. No.: 19/344,810

(22) Filed: Sep. 30, 2025

Related U.S. Application Data
(63) Continuation of application No. PCT/EP2024/059231, filed on Apr. 4, 2024.

(30) Foreign Application Priority Data
Apr. 6, 2023 (EP) 23167116.5

(51) Int. Cl. B65D 25/34; B05D 7/16

(52) U.S. Cl. CPC B65D 25/34; B05D 7/16; B05D 2202/25; B05D 2252/02; B65D 2517/0082

(57) ABSTRACT

A strip-shaped pre-product for manufacturing can lids or can tabs of a can, preferably a beverage can having an aluminium alloy strip with at a least partial surface coating. The surface coating is provided on the side of the aluminium alloy strip used for the outer side of the can. A coated aluminium alloy strip is provided for manufacturing a can lid or a can tab, preferably a beverage can manufactured from a strip-shaped pre-product. A second coating is arranged on the first coating of the pre-product. The object of specifying a simple possibility of providing aluminium alloy strips with less sensitive lacquer layers, preferably coloured lacquer layers for the manufacture of can lids or can tabs, in particular beverage can lids and beverage can tabs, is achieved by means of a strip-shaped pre-product and with an aluminium alloy strip as well as by a method for its manufacture.

### CROSS-REFERENCE TO RELATED PATENT APPLICATIONS

This patent application is a continuation of International Application No. PCT/EP2024/059231, filed on Apr. 4, 2024, which claims the benefit of priority to European Patent Application No. 23167116.5, filed Apr. 6, 2023, the entire teachings and disclosures of both applications are incorporated herein by reference thereto.

### FIELD OF THE INVENTION

The invention relates to a strip-shaped pre-product for manufacturing can lids or can tabs of a can, preferably a beverage can having an aluminium alloy strip with at least one first at least partial surface coating having a cross-linkable coating substance, which is provided on the side of the aluminium alloy strip used for the outer side of the can. The invention further relates to an aluminium alloy strip for manufacturing a can lid or a can tab, preferably a beverage can manufactured from a strip-shaped pre-product according to the invention having at least one second coating, which is arranged on the at least one first coating of the pre-product. Finally, the invention relates to a method for the production of an aluminium alloy strip according to the invention.

### BACKGROUND OF THE INVENTION

Can lids and can tabs, preferably of beverage cans, are often manufactured using coated aluminium alloy strips. The coated aluminium alloy strips are adapted to the respective application case, i.e. to the specific can application, both in terms of the aluminium alloy strip used and in terms of the coating. This results in different requirements for the inside and outside of a can, preferably a beverage can. While the coated inner side of a can generally has to protect the aluminium alloy from the influences of the contents of the can and vice versa the contents of the can from the aluminium alloy, in addition to improving the forming properties, the outer side primarily has the task of determining the appearance, i.e. the optics, of the can, in particular the beverage can. Coloured lacquers and clear lacquers are therefore also increasingly used in the coating of aluminium alloy strips for the manufacture of can lids or can tabs.

Most lacquers or other coatings are usually subjected to a curing process by heating, also known as burn-in. This plays an important role in the subsequent properties of the coated aluminium alloy strip, as the burn-in process influences or specifies the strength of the coated aluminium alloy strip.

The burn-in process is carried out at the so-called burn-in temperature. The burn-in temperature refers to the temperature required for the full curing of coating materials for a specified burn-in time. It is always specified in this document in the form of the “peak metal temperature” (PMT) of the aluminium alloy strip. For this purpose, the holding time at the maximum temperature (PMT) is also specified in order to define the burn-in process. The PMT is only reached after a certain preheating time; it is therefore usually lower than, for example, the circulating air temperature of a convection furnace. The PMT can easily be measured by thermocouples on test specimens in the furnace pass.

Coloured lacquers are increasingly being used, in particular coloured lacquers with a high contrast to the natural aluminium colour on the outside of the can, for example for can lids. This results in problems when processing the aluminium alloy strips. Can lids are stored in stacks for processing and processed further after storage. During storage or further processing in the can manufacturing process, the lids rotate against each other. The protruding crown, a circumferential elevation of the can lid, is particularly susceptible to lacquer defects caused by lacquer scraping or chipping. The lacquer layer in these areas is particularly sensitive after forming on the top of the crown, as the lacquer layer must withstand high tensile stresses due to forming. In addition, due to the small contact surface for other can lids, the crown is subjected to comparatively high contact pressures, which further increases the risk of lacquer damage. Due to the strong contrast between the uncoated, silver-coloured aluminium and the coloured lacquer layer, even extremely small chips in the coloured lacquer layer can be visible to the naked eye. The damage to the lacquer layer leads to an unwanted appearance of the can, for example a beverage can. The same generally applies to the can tabs.

To reduce the risk of lacquer damage, the coloured lacquer layer is therefore coated with a clear lacquer to create a two-layer lacquer system. The corresponding aluminium alloy strip therefore goes through two separate burn-in steps, which are usually carried out at a uniform burn-in temperature. Compared to a single burn-in step, this leads to a reduction in the strength of the aluminium alloy strip because the burn-in temperatures of both coatings initiate softening processes in the aluminium alloy strip. The strength of the aluminium alloy strip is significantly reduced compared to aluminium alloy strips exposed to only a single burn-in process. This applies in particular to the usual burn-in temperatures of 245° C. to 270° C., at which the temperature threshold for recrystallisation of the aluminium alloy of the aluminium alloy strip is partially exceeded.

In addition, the two-coat system continues to cause the clear lacquer layer to peel off, as the clear lacquer layer does not have sufficient adhesion to the coloured lacquer layer in certain areas. These are also visible on the finished can. It has also been shown that the temperatures of the burn-in steps can also influence the colour shade of the lacquer layer and discolouration of the coloured lacquer layer can occur. Finally, the energy required to provide a two-layer coating system with identical burn-in steps is significantly increased compared to an aluminium alloy strip with a single layer of lacquer.

A two-layer lacquer-coated aluminium strip in which both lacquer layers are cured individually is known from the U.S. Pat. No. 4,253,584. A partial cross-linking of the first coating is not known.

The international patent application WO 2008/036628 A1 shows an aluminium strip coated with a water-based coating for a beverage can that is only formed in a single layer.

The use of polyester as a substitute for PVC in a single-layer coating on the inside of a can lid is known from the international patent application WO 98/23198 A1.

Single-layer coatings of a beverage can that do not release potentially hazardous substances are provided by the international patent application WO 2004/013240 A1 for beverage cans.

The international patent application WO2015/002958 A1 discloses single-layer, coatings containing latex for beverage containers.

### SUMMARY OF THE INVENTION

The object of the invention is therefore to indicate a simple way of providing aluminium alloy strips with less sensitive lacquer layers, preferably coloured lacquer layers for the manufacture of can lids or can tabs, in particular beverage can lids and beverage can tabs. The aluminium alloy strip should also preferably require less energy for production.

According to a first teaching, the object shown above is achieved by a strip-shaped pre-product in that the at least one first coating of the aluminium alloy strip has a cross-linking degree of at least 20% to 80%, preferably 30% to 70%, more preferably 45% to 60%, and the aluminium alloy strip achieves an unchanged surface result of the coated side in a so-called block test, wherein for the block test two blanks, for example with the dimensions 10 cm×10 cm, from which the pre-product with its partially cross-linked, first coatings pointing in the same direction are laid on top of one another between two planar pressure bodies, the cut-outs laid on top of each other are pressed against each other over the pressure bodies with a pressure of at least 2.942 kPa and are heated and held for 24 hours in this state at 50° C. PMT, the blanks are then separated again and, after separating the blanks, the surface of the coating of the two blanks is examined for changes.

An unchanged surface result is achieved if the coated sides of the blanks have no visible optical changes after the blanks have been separated, i.e. are unchanged. With this result, the pre-product can be wound into a coil without any problems and processed later.

A negative result in the block test, on the other hand, is characterised by a change in the surface due to the formation of dull spots in the area of pressure application of the blanks after separating. The matt areas of the surface are due to excessive adhesion of the blanks in the block test. This leads to damage to the coating surface when separating the blanks.

In addition, even stronger adhesion of the blanks in the block test can even lead to partial or complete tearing off of the coating of a blank. Both dull spots and partial or complete tearing of the coating lead to a surface change of the coating. As a result, the pre-product cannot be wound onto a coil for further processing.

The degree of cross-linking of the at least one first coating can for example be determined by the so-called “sol fraction test”. A sample of fixed geometry of the pre-product is first weighed (unloaded). The sample is then placed in a methyl ethyl ketone (MEK) bath for 30 minutes at room temperature and dried (loaded) in a laboratory oven at 180° C. for two minutes. In this step, coating portions that are not cross-linked are essentially removed. The sample is weighed again and then the lacquer layer is removed so that the sample is only made up of metal (metal). Finally, the sample is weighed again. The quotient of the difference between the weight of the unloaded sample and the loaded sample and the difference between the weight of the unloaded sample and the metal weight then results in the coating portion that is not cross-linked.

Surprisingly, it has been shown that the strip-shaped pre-product according to the invention can provide significantly improved cross-linking between the first and the second coating due to the insufficiently cross-linked state of the at least one first coating. It was found that after coating with the at least one second coating and burn-in of both layers, the cross-linking also takes place strongly between the layers. As a result, the at least one second coating adheres significantly better to the first coating. For example, chipping of a clear lacquer layer at critical points of a can lid could be significantly reduced. The unchanged surface after the block test ensures that the pre-product according to the invention with the insufficiently cross-linked coating does not tend to stick, for example when winding onto a coil. If the block test is successful, the pre-product can be wound onto a coil and stored without any problems during subsequent processing. The pre-product according to the invention can therefore, for example, be easily uncoiled again after storage and processed into the finished coated aluminium alloy strip for can lids or can tabs. This enables the economical manufacture of an aluminium alloy strip for the manufacture of can lids and can tabs, in particular of beverage cans with at least two-layer coating.

The aluminium alloy strip optionally has a passivation layer prior to coating with the at least one first coating, which is provided on one or both sides and on which the at least one first coating is arranged. The passivation layer is preferably formed without chromium. This results in processing advantages with regard to safety precautions with chemicals containing chromium in operation. The passivation layer can for example be provided by zirconium phosphating of the aluminium alloy strip. The passivation layer increases the adhesion of the at least one first coating on the aluminium alloy strip.

According to a first embodiment of the pre-product according to the invention, the at least one first coating of the aluminium alloy strip has a burn-in temperature (PMT) between 180° C. and 240° C., preferably 200° C. to 230° C., particularly preferably 210° C. to 220° C., with a holding time of 1 to 20 seconds, preferably 2 to 12 seconds; due to the reduced burn-in temperature, the loss of strength of the aluminium alloy strip during burn-in of the at least one first coating can be minimised and still a partial curing of the at least one first coating can be achieved. At the same time, less energy is also required for the first burn-in process due to the lower burn-in temperature.

Good adjustability of the burn-in temperature via the lacquer composition can be made possible by a further embodiment in that the at least one first coating of the aluminium alloy strip is formed by an epoxy amine lacquer system or a polyester amine lacquer system. The lacquer systems can be well adjusted by the lacquer manufacturer to specified burn-in temperatures by changing the chemical composition, for example by changing the binder.

Since the burn-in time in particular also depends on the layer thickness of the at least one first coating, it is advantageous if the at least one first coating of the aluminium alloy strip has a layer thickness of 2 g/m² to 5 g/m². This layer thickness guarantees short burn-in times while at the same time providing good cross-linking or adhesion to at least one second coating. At the same time, these coat thicknesses are sufficient to ensure sufficient colouration in a coloured lacquer coat.

Due to the good properties of the strip-shaped pre-product according to the invention in the block test, this can be further processed or stored in a simple manner by the strip-shaped pre-product being wound on a coil. For example, the pre-product can be easily fed into further coating steps and an economical production method can be guaranteed.

If the aluminium alloy strip of the pre-product according to a further embodiment has an aluminium alloy of type AA3004, AA3104, AA3105, AA5052, AA5042 or AA5182 and if the metal thickness of the aluminium alloy strip is 0.12 mm to 0.30 mm, preferably 0.16 mm to 0.25 mm, particularly preferably 0.16 mm to 0.23 mm, aluminium alloy strips for the manufacture of can lids or can tabs with the necessary strengths can be provided economically.

According to a preferred embodiment, the at least one first coating is a coloured lacquer layer. As already shown above, the pre-product according to the invention can advantageously be used for the production of aluminium alloy strips for can lids and can tabs, which are particularly insensitive with respect to lacquer flaking, i.e. insensitive with respect to scratches and abrasions of lacquer layers.

Finally, according to a further embodiment, the pre-product has a passivation layer on the side of the aluminium alloy strip used for the outer side and/or on the inner side of the can for adhesion before coating the respective sides. A passivation layer improves adhesion between the coating and the aluminium material of the aluminium alloy strip. This applies both to the side of the aluminium alloy strip intended for the outside of the can and to the side of the aluminium alloy strip intended for the inside. The passivation of the side of the aluminium alloy strip provided for the inner side can optionally also take place after the application of the at least one first coating on the side of the aluminium alloy strip provided for the outer side.

According to a further teaching, the objective set out is achieved by an aluminium alloy strip for manufacturing a can lid or a can tab, preferably a beverage can, in that it is manufactured from a strip-shaped pre-product according to the invention and that at least one second coating is provided, which is arranged on the at least one first coating of the pre-product. As already stated above, the aluminium alloy strip according to the invention has improved cross-linking between the at least one first coating and the at least one second coating. The aluminium alloy strip having a two-layer coating therefore differs from the conventionally manufactured aluminium alloy strips by stronger cross-linking of the two coatings with each other and thus by a stronger adhesion between the two coatings. At the same time, the use of the pre-product according to the invention ensures a particularly economical manufacture of the aluminium alloy strips.

According to a first embodiment, the at least one first coating and the at least one second coating have a cross-linking degree of more than 90%, preferably more than 95%, particularly preferably more than 98%, wherein the at least one first coating has a lower burn-in temperature than the second coating, and preferably the burn-in temperature of the at least one second coating is 245° C. to 270° C. PMT, preferably 245° C. to 260° C. PMT, particularly preferably 248° C. to 255° C. PMT with a holding time of 1 to 20 seconds, preferably 2 to 12 seconds.

Due to the lower burn-in temperatures of the at least one first coating, an aluminium alloy strip with a two-layer coating can be provided, which avoids the aforementioned disadvantages of greater loosening and significantly higher energy consumption. Due to the improved cross-linking between the at least one first coating and the at least one second coating, the two-layer coating is simultaneously more scratch-resistant than conventionally manufactured two-layer coatings.

The aluminium alloy strip according to the invention preferably has exactly two coatings with a cross-linking degree of more than 90%, preferably more than 95%, particularly preferably more than 98%. Corresponding two-layer coatings can meet the requirements for can lids and can tabs in a particularly economical way, as each further coating requires additional burn-in processes.

As already mentioned above, the burn-in temperatures can be set very accurately by providing the at least one second coating via an epoxy amine lacquer system or a polyester amine lacquer system. The aforementioned lacquer systems can be well adjusted by selecting a modified composition in relation to the burn-in temperatures, for example by changing the binder.

The at least one second coating has a substantially identical layer thickness as the at least one first coating. For this purpose, the at least second coating has an area weight of preferably 2 to 5 g/m². Furthermore, the at least one second coating is optionally formed as a clear lacquer layer, such that it can protect the coloured lacquer layer, for example, without disturbing the colour impression of the coloured lacquer layer.

If the aluminium alloy strip according to a next embodiment has an aluminium alloy of type AA5182 and, after burn-in the at least one first and a second coating, the tensile strength Rm of the aluminium alloy strip is 380 MPa to 425 MPa and the yield strength R_{p0.2} of the aluminium alloy strip is 330 MPa to 380 MPa, high-strength aluminium alloy strips for can lids can be provided which have at least one two-layer coating, preferably having a two-layer coating on the outside.

According to a further teaching of the invention, the objective for a method for producing an aluminium alloy strip with at least one first coating and at least one second coating which is arranged on the first coating is achieved by firstly producing a pre-product by coating an aluminium alloy strip with at least one first coating, wherein the at least one first coating of the pre-product is cured in a first burn-in step up to a cross-linking degree of 20% to 80%, preferably 30% to 70%, more preferably 45% to 60%, wherein the pre-product achieves an unchanged surface result of the coated side after a block test, and the at least one first coating of the pre-product is coated with at least one second coating and subsequently the at least one first coating and the at least one second coating are cured together in a second burn-in step. The pre-product can preferably be wound onto a coil and stored before applying the second coating.

It has been shown that the problems with peeling lacquered areas, for example in the case of can lids or can tabs, can be significantly reduced by providing improved adhesion between the previously not completely cross-linked at least one first coating and the at least one second coating arranged on the at least one first coating by burn-in both coatings in the second burn-in step. This results in a significantly stronger cross-linking of the two coatings with each other. At the same time, high economic efficiency can be achieved by manufacturing a storable pre-product with a subsequent second coating process of the finished aluminium alloy strip in the manufacture of the coated aluminium alloy strip for the manufacture of can lids or can tabs while simultaneously providing an advantageous at least two-layer lacquer system on the aluminium alloy strip.

If, according to a first embodiment of the method, the at least one first coating is cured with a burn-in temperature which is lower than the burn-in temperature of the second coating arranged on the first coating, wherein preferably the at least one first coating is cured at a burn-in temperature (PMT) of 180° C. to 240° C., preferably 200° C. to 230° C., particularly preferably 210° C. to 220° C., with a holding time of at least 1 to 20 seconds, preferably 2 to 12 seconds, not only less energy is required for the burn-in process, but also the loosening of the aluminium alloy strip is limited despite the provision of a two-layer coating system. As a result, fully baked aluminium alloy strips with at least two-layer coatings can be provided with lower energy requirements.

If the pre-product is wound into a coil after coating with the at least one first coating and partial curing of the at least one first coating, this can be stored in a simple manner and provided for subsequent coating with the at least one second coating.

After the coating with the at least one second coating, the at least one first coating and the at least one second coating are preferably cured together in a second burn-in step, wherein the burn-in temperature in the second burn-in step is higher than the burn-in temperature of the at least one first coating, preferably wherein in the second burn-in step the curing is at a burn-in temperature (PMT) of 245° C. to 270° C., preferably 245° C. to 260° C., particularly preferably 248° C. to 255° C., with a holding time of 1 to 20 seconds, preferably 2 to 12 seconds. This ensures safe curing of the two-layer coating system and at the same time achieves a coated aluminium alloy strip with lower loosening than conventional aluminium alloy strips with two-layer lacquer systems.

### BRIEF DESCRIPTION OF THE DRAWINGS

The invention will be explained in more detail below on the basis of exemplary embodiments, The drawing shows

FIG. 1 is a schematic sectional view the manufacture of an aluminium alloy strip for cans, in particular beverage cans,

FIG. 2 is a schematic sectional view a method for manufacturing a pre-product by coating an aluminium alloy strip,

FIG. 3 is a schematic sectional view the method for manufacturing an aluminium alloy strip with two layers of lacquer arranged one above the other using the pre-product according to the invention,

FIG. 4 is a schematic diagram the course of the burn-in process over time at different burn-in temperatures but with the same holding time,

FIG. 5 is embodiments of the pre-product according to the invention and the aluminium alloy strip according to the invention in a schematic sectional view and

FIG. 6 is a schematic top view a sample of a lacquered strip with markings for evaluating the impact fold test.

### DETAILED DESCRIPTION

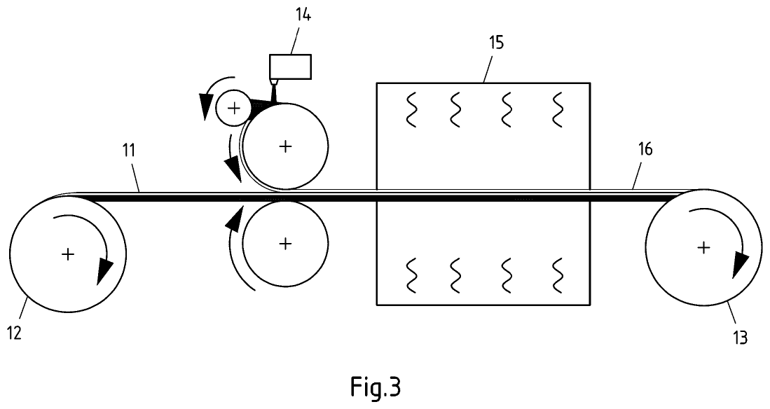

FIG. 3 shows, in a schematic view, the individual method steps for manufacturing an aluminium alloy strip from the manufacturing of the rolling ingots to the cold rolling of the aluminium strip at end thickness.

First, a rolling ingot 1 is manufactured, for example in the DC casting process. Similarly, a strip casting not represented here can also be used to manufacture a cast strip. The rolling ingot 1 is then subjected to homogenisation in step 2a and then hot-rolled to form a hot strip 3 in step 3a. Hot rolling can be carried out in reversing stands and/or in tandem stands with multiple passes. The hot strip is then cold-rolled to an end thickness in step 4a to form a cold strip 4. Cold rolling can be carried out in rolling racks with a single rolling pass or in multiple racks with two or more rolling passes. During cold rolling, one or more intermediate annealing processes 4b can take place in chamber furnace 5 or a continuous furnace that is not shown. A final heat treatment is also not excluded, however, preferably the cold-rolled aluminium alloy strips in the full-hard H18 or H19 rolling state are fed to the next method step of the coating. At the end of the cold rolling, the cold rolled aluminium alloy strip 4 is preferably wound onto a coil 6.

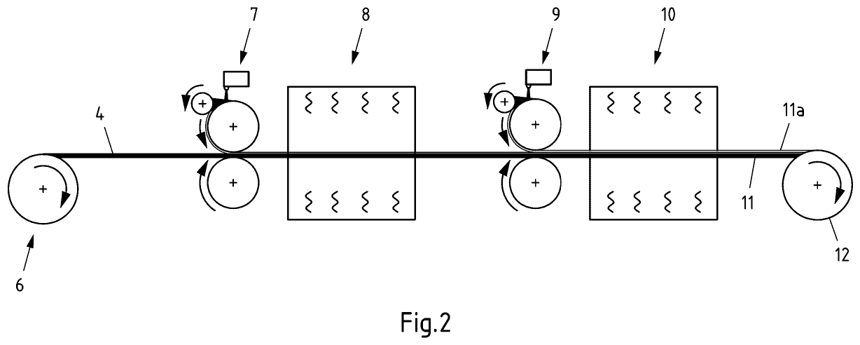

An embodiment of a method for manufacturing a pre-product by coating an aluminium alloy strip is shown in FIG. 2. The cold-rolled aluminium alloy strip 4 is unwound from a coil 6 and fed into an optional passivation step 7, which is designed here as a roll coating process. Alternatively, the passivation chemical can also be sprayed on, for example electrostatic spraying of the passivation chemical. Alternatively, passivation can also be carried out by passing through a bath with the passivation liquid. However, the roll coating process has proven its worth due to the possible high throughput speeds and the good accuracy of the passivation chemical application. No-rinse processes are preferred for surface passivation, in which the passivation agent, preferably zirconium phosphate, remains on the aluminium strip and does not need to be rinsed off. For this purpose, the aluminium alloy strip 4 coated with a passivation chemical is dried in an oven 8 after application of the passivation chemical.

Not shown in FIG. 2 is an optional pretreatment also of the lower side of the aluminium alloy strip 4, which can for example also be provided with a passivation layer as well. The passivation agent can then be dried. Here, as well, the use of zirconium phosphate is preferred. Thus optionally, both sides of the aluminium alloy strip have passivation layers.

In the next step, the aluminium alloy strip 4 for providing the pre-product according to the invention is coated with at least one first coating 11a, for example in the roll coating method 9. Alternatively, it is also conceivable to use other application processes that are not shown here.

Preferably, the at least one first coating 11a is provided via a coloured lacquer. The coating preferably has a lacquer system, particularly preferably an epoxy amine lacquer system or a polyester amine lacquer system, which has a burn-in temperature (PMT) between 180° C. and 240° C., preferably 200° C. to 230° C., particularly preferably 210° C. to 220° C., with a holding time of 1 to 20 seconds, preferably 2 to 12.

In the furnace 10, the curing of the at least one first coating 11a of the aluminium alloy strip is then carried out in a first burn-in step, wherein a degree of cross-linking of at least 20% to 80%, preferably 30% to 70%, more preferably 45% to 60% is achieved and the aluminium alloy strip achieves an unchanged surface result of the coated side after the block test described above. Due to the lower burn-in temperature, less energy is required for the first burn-in step in furnace 10.

Subsequently, the pre-product 11 according to the invention, i.e. an aluminium alloy strip provided with at least one first coating, is optionally wound into a coil 12. As an alternative to winding the pre-product 11 onto a coil 12, the pre-product 11 could be fed directly into the next coating process for coating the at least one second coating arranged on the at least one first coating.

However, since the pre-product according to the invention has an unchanged surface result in the block test, the pre-product 11 wound on the coil 12 can easily be stored and subsequently further processed for further coating with at least one second coating on the at least one first coating.

FIG. 2 shows the coating in the roll coating method 9 with at least one first coating in connection with the application 7 and drying 8 of the passivation layer. Alternatively, due to different process speeds, the application of the passivation layer on the strip surfaces and the application of the at least one first coating can also take place separately from each other and in devices which, as shown in FIG. 3, perform only one coating step and one drying step at a time. This allows to optimally adapt the speed of the strips to the different application processes and material properties, in particular drying properties.

FIG. 3 now shows an embodiment in which the pre-product 11 is uncoiled from coil 12 and fed into a further coating step 14 in the form of a roll coating process. Here, too, other alternative coating processes could be used, but these are not shown. The aluminium alloy strip 16 provided with a two-layer coating is then hardened in a second burn-in step in the furnace 15 and wound onto a coil 13.

In the second burn-in step, the at least one first coating and the at least one second coating are cured up to a cross-linking degree of more than 90%, preferably more than 95%, particularly preferably more than 98% in the furnace 15, wherein the at least one second coating has a higher burn-in temperature than the at least one first coating. In furnace 15, both layers are baked with the higher burn-in temperature.

In the second burn-in step in the furnace 15, a burn-in temperature (PMT) of 245° C. to 270° C. is preferably used, more preferably 245° C. to 260° C., particularly preferably 248° C. to 255° C., with a holding time of 1 to 20 seconds, preferably 2 to 12 seconds.

As shown in FIG. 3, the lower side of the aluminium alloy strip, which is for example provided for the inside of the beverage can, can also be provided with a passivation and/or coating in the roll coating process, which is then dried or baked in an oven. The use of other coating processes is also conceivable here.

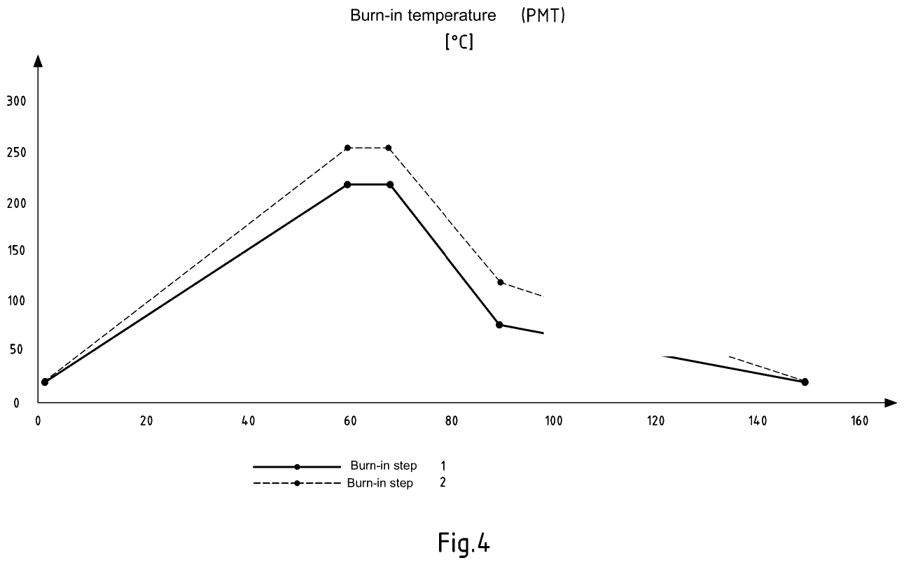

FIG. 4 shows a schematic diagram view of two time courses of the PMT of idealised burn-in processes which result from different burn-in temperatures, once at 220° C. for the first burn-in step in furnace 10 and 255° C. for the second burn-in step in furnace 15 with an identical holding time of 8 seconds. The curves are represented in a highly idealised way.

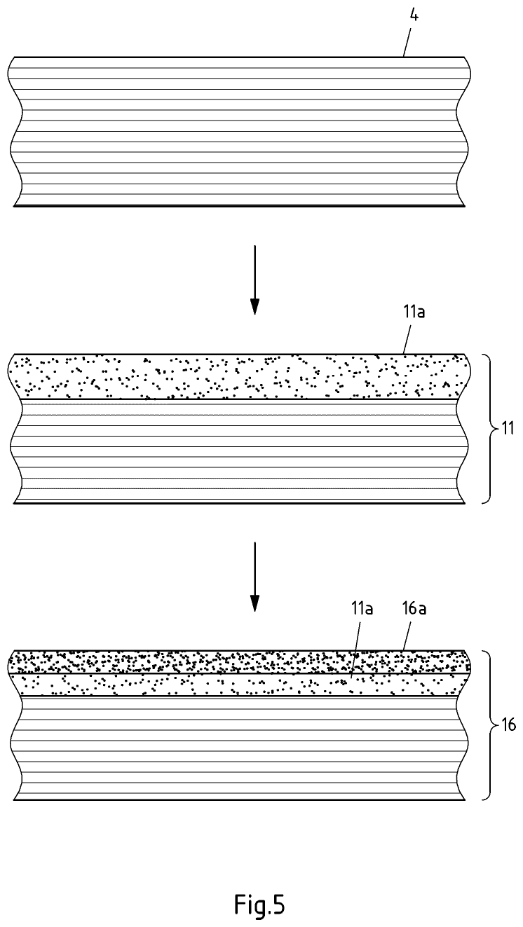

FIG. 5 shows, based on the aluminium alloy strip, which prefers an aluminium alloy of type AA3004, AA3104, AA3105, AA5052, AA5042 or AA5182 and has a metal thickness of 0.12 mm to 0.30 mm, preferably 0.16 mm to 0.25 mm, particularly preferably 0.16 mm to 0.23 mm, both the pre-product 11 and the finished aluminium alloy strip 16. The pre-product 11 and the finished aluminium alloy strip 16 are shown in FIG. 5 without the optional passivation layer.

The layer thicknesses of the at least one first coating 11a of the pre-product 11 and the at least one second coating 16a of the finished aluminium alloy strip 16 are preferably 2 g/m² to 5 g/m² in order to provide the necessary properties for the coating system for example of an aluminium alloy strip for manufacturing can lids or can tabs.

Various studies were carried out on coated aluminium alloy strips in order to illustrate the advantages of the pre-product according to the invention and the finished aluminium alloy strip according to the invention.

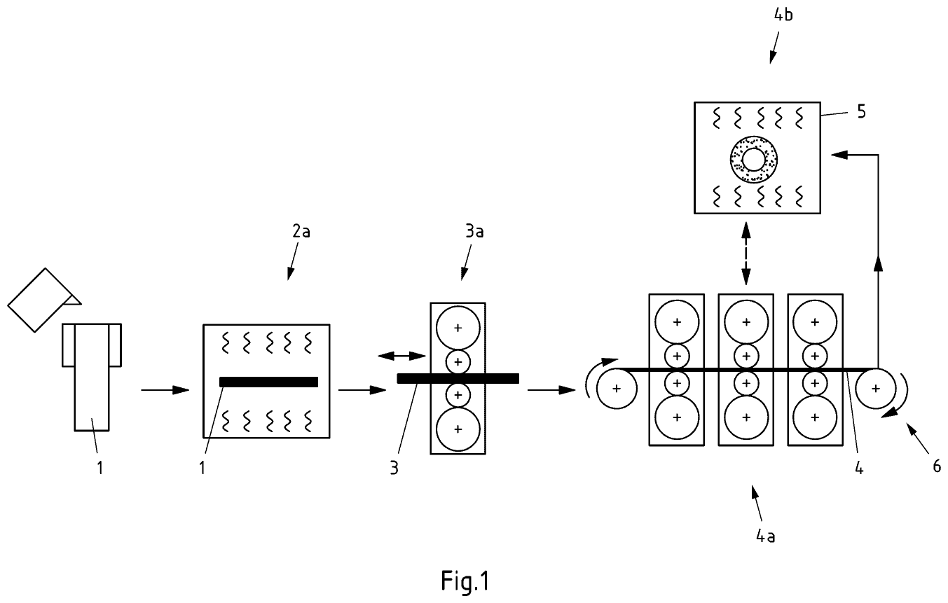

Table 1 shows the results of the investigations. Aluminium alloy strips having an aluminium alloy of type AA5182, and are used for the manufacture of can lids of a beverage can according to the manufacturing process depicted schematically in FIG. 1.

Two comparative pre-products A and C as well as a pre-product B according to the invention were manufactured from the aluminium alloy strips manufactured in this way. The pre-products differ only in the degree of cross-linking as well as in the burn-in temperature with a fixed holding time of 2 to 12 seconds of the respective coating. While a conventional coating with a burn-in temperature of 250° C. to 340° C. at a holding time of 1 to 12 seconds was used for the comparative pre-product A, the burn-in temperature was 200° C. to 290° C. for the pre-product according to the invention and 150° C. to 240° C. for the comparative pre-product. The respective test strips were then baked under the conditions specified in Table 1.

The at least one first coating of the comparison strips A and C were baked with a PMT of 249° C. (comparison band A) and 170° C. (comparison band C) respectively. The holding time was 2 s each.

Differences emerged after burn-in the first coating in tests A, B and C due to the degree of cross-linking. While test A had almost complete cross-linking of 91% in the “sol fraction test”, the pre-product B according to the invention had a cross-linking degree of 55% and the comparative pre-product C only had a cross-linking degree of 17%. The area weights of the at least one first coating of the examined strip-shaped pre-products were all identical and were 4 g/m².

A block test was carried out with the coated aluminium alloy strips manufactured in this way. In the block test, two blanks from the pre-product with a size of 10×10 cm from the coated aluminium alloy strip were placed with the first coating pointing upwards on a first flat pressure body, for example with an edge length of 15 cm×15 cm, and pressed against each other via a further pressure body with a pressure of 2.942 kPa. When pressed together, the blanks were heated to 50° C. PMT and kept in this state for 24 hours. The blanks were subsequently separated again and, after separating the blanks, the surface of the at least one first coating of the two blanks was examined for changes.

Tests A and B showed no changes in the results, so the corresponding test strips A and B could easily be wound into a coil. A negative result was obtained in the block test for comparison strip C. Here, the too low cross-linking rate of 17% was noticeable due to a slight bonding of the surfaces of the cut-outs. As a result, a second coating could not be applied to test pre-product C, as the layers stick together when winding onto a coil. In this respect, the pressure of at least 2.942 kPa used in the block test determines the behaviour in the coiled state of the pre-product.

The workability and susceptibility to lacquer flaking were also examined. For this purpose, an impact fold test was carried out with an Erichsen impact fold test device, model 471. The impact test simulates common sheet processing steps such as punching, folding and flanging on samples with a size of 50×140 mm and thicknesses in the range of 0.1 mm to 0.35 mm.

For the impact fold test, a specimen of 50×140 mm was cut from test strips A and B provided with at least the second coating, each with the long side transverse to the rolling direction, and bent along the long centre line around the cylindrical bending mandrel with a diameter of 5 mm. Deformation takes place from a previously cylindrical bending edge with a diameter of 5 mm to a conical one due to impact stress. An assessment is carried out to determine the bending radius from which the coating exhibits damage. The smaller the radius, the better the coating can withstand mechanical loads without problems.

The impact fold test device consists of a parallel guided hammer with a weight of 2300±100 g and a drop height of 650±5 mm. A specially shaped, conical anvil serves as a support for the pre-bent sample sheet. The hammer is hung between the two upper retaining pins. The pre-bent sample sheet is placed on the anvil so that one of the two side edges hits the stop. The folding impact is then triggered.

In a test liquid mixed in 1 L of distilled water

$$100 g copper sulphate ( Cu SO 4 \cdot 5 H 2 O ) ,$$

$$50 g citric acid ,$$

$$200 g 37 \% hydrochloric acid = 168 ml ,$$

the samples were immersed for 5 minutes and then rinsed well under running water. The damage to the coating becomes visible either as corrosion lines or as corrosion spots. As a measurement result, the distance length of an outer corrosion line in the area of the conical deformation outside the maximum fold is measured in mm.

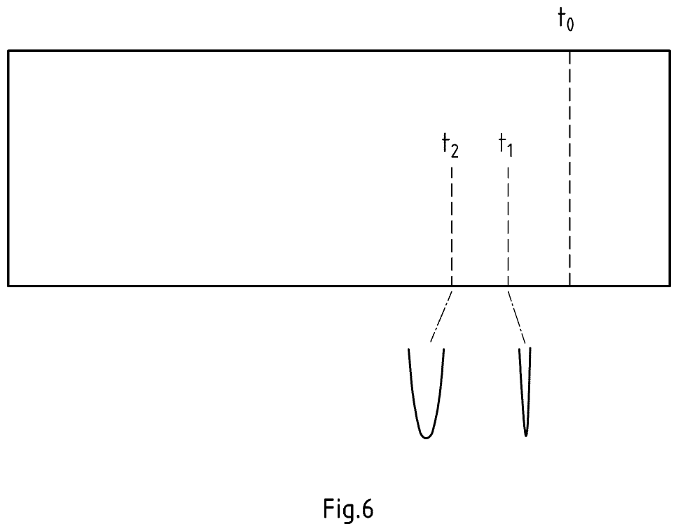

FIG. 6 now shows a schematic planar view of a sample of a coated aluminium strip after the impact fold test. First, the area of the specimen at which the conical anvil has not created a bend in the specimen is defined as to. Subsequently, the point t₁ is determined at which the maximum folding of the sample where both sides of the sample lie on top of each other ends and transitions into a bend of the samples with a rising bending radius to the left due to the anvil geometry as shown in FIG. 6.

Furthermore, the point along the bending edge of the sample where a corrosion line is no longer visible due to the attack of the acidic test liquid is also shown as t₂ in FIG. 6. This is done, for example, with a magnifying glass with 10× magnification. The shorter the measured distance between t₁ and t₂, the smaller the bending radii allowed by the coating without corrosion problems and the better the deformability of the coating (see operating instructions for impact fold testing device model 471, from Erichsen). FIG. 6 also shows the corresponding sample cross-sections at points t₁ and t₂ in a schematic view.

The comparison strips A achieved measurement values of 25 mm on average, which corresponded exactly to the permissible limit value. The aluminium alloy strips B according to the invention achieved results in the impact fold test with an average of 15 mm, which indicates significantly better processing properties. They are therefore more resistant to chipping.

The tests showed that the pre-products according to the invention have very good processing properties and the aluminium alloy strips coated according to the invention are significantly more resistant to damage than previously manufactured aluminium alloy strips with conventionally manufactured two-layer coating.

TABLE 1

| | | First coating | | | | | Second coating | | | |
|---|---|---|---|---|---|---|---|---|---|---|
| | | Burn-in | Sol | | | | Burn-in | | | Ease of |
| | | temperature | fraction | | | | temperature | | | processing |
| | | and duration | test | PMT | Time | Block | and duration | PMT | Time | Impact |
| Test | | of the coating | [%] | [° C.] | [s] | test | of the coating | [° C.] | [s] | fold test⁵ |
| A | Comparison | 1-12 s at | 91% | 249 | 2 | OK | 1-12 s at | 249 | 2 | 25 mm |
| | | 250° C. to | | | | | 250° C. to | | | |
| | | 340° C. | | | | | 340° C. | | | |
| B | Invention | 1-12 s at | 55% | 216 | 2 | OK | 1-12 s at | 249 | 2 | 15 mm |
| | | 200° C. to | | | | | 250° C. to | | | |
| | | 290° C. | | | | | 340° C. | | | |

| | | | | | | | | | |
|---|---|---|---|---|---|---|---|---|---|
| C | Comparison | 1-12 s at | 17% | 170 | 2 | not OK | 1-12 s at | not possible | not possible |

| | | |
|---|---|---|
| 150° C. to | (light | 250° C. to |
| 240° C. | sticking) | 340° C. |

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. Strip-shaped pre-product for manufacturing can lids or can tabs of a can, preferably a beverage can having an aluminium alloy strip with at least one first at least partial surface coating having a cross-linkable coating substance which is provided on the side of the aluminium alloy strip used for the outer side of the can,
wherein
the at least one first coating of the aluminium alloy strip has a degree of cross-linking of at least 20% to 80%, preferably 30% to 70%, more preferably 45% to 60%, wherein the degree of cross-linking is measured according to the “sol fraction test” referred to in the description and the aluminium alloy strip achieves an unchanged surface result of the coated side in a block test according to the description, wherein for the block test two blanks from the pre-product with their partially cross-linked, first coatings pointing in the same direction are placed on top of each other between two flat pressure bodies, the cut-outs laid on top of each other are pressed against each other over the pressure bodies with a pressure of at least 2.942 kPa and are heated and held for 24 hours in this state at 50° C. PMT, then the cut-outs are separated again and after the separation of the cut-outs the surface of the coating of the two cuts are examined for changes.

2. Pre-product according to claim 1,
wherein
the at least one first coating of the aluminium alloy strip has a burn-in temperature between 180° C. and 240° C. PMT (peak metal temperature), preferably 200° C. to 230° C. PMT, particularly preferably 210° C. to 220° C. PMT, with a holding time of 1 to 20 seconds, preferably 2 to 12 seconds.

3. Pre-product according to claim 1,
wherein
the at least one first coating of the aluminium alloy strip is formed by an epoxy amine lacquer system or a polyester amine lacquer system.

4. Pre-product according to claim 1,
wherein
the at least one first coating of the aluminium alloy strip has a layer thickness of 2 g/m² to 5 g/m².

5. Pre-product according to claim 1,
wherein
the strip-shaped pre-product is wound on a coil.

6. Pre-product according to claim 1,
wherein
the aluminium alloy strip is an aluminium alloy of type AA3004, AA3104, AA3105, AA5042, AA5052 or AA5182, the metal thickness of the aluminium alloy strip is 0.12 mm to 0.30 mm, preferably 0.16 mm to 0.25 mm, particularly preferably 0.16 mm to 0.23 mm.

7. Pre-product according to claim 1,
wherein
the at least one first coating is a coloured lacquer layer.

8. Pre-product according to claim 1,
wherein
the pre-product has a passivation layer on the side of the aluminium alloy strip used for the outer side and/or for the inner side of the can for adhesion before coating the respective side.

9. Coated aluminium alloy strip for manufacturing a can lid or a can tab, preferably a beverage can manufactured from a pre-product according to claim 1 having at least one second coating which is arranged on the at least one first coating of the pre-product.

10. Aluminium alloy strip according to claim 9,
wherein
the at least one first coating and the at least one second coating have a cross-linking degree of more than 90%, preferably more than 95%, particularly preferably more than 98%, wherein the at least one first coating has a lower burn-in temperature than the second coating, and preferably the burn-in temperature of the at least one second coating is 245° C. to 270° C. PMT, more preferably 245° C. to 260° C. PMT, particularly preferably 248° C. to 255° C. PMT, with a holding time of 1 to 20 seconds, preferably 2 to 12 seconds.

11. Aluminium alloy strip according to claim 9,
wherein
the at least one second coating has an epoxy amine lacquer system or a polyester amine lacquer system.

12. Aluminium alloy strip according to claim 9,
wherein
the at least second coating has an area weight of 2 to 5 g/m², wherein the at least one second coating is optionally a clear lacquer layer.

13. Aluminium alloy strip according to claim 9,
wherein
the aluminium alloy strip has an aluminium alloy of type AA5182 and the aluminium alloy strip (16) has a tensile strength Rₘ of 380 MPa to 425 MPa and a yield strength of R_{p0.2} of 330 MPa to 380 MPa after the burn-in of the at least one first and one second coating.

14. Method for manufacturing an aluminium alloy strip according to claim 9 using the pre-product that is strip shaped for manufacturing can lids or can tabs of a can, preferably a beverage can having an aluminium alloy strip with at least one first at least partial surface coating having a cross-linkable coating substance which is provided on the side of the aluminium alloy strip used for the outer side of the can,
wherein
the at least one first coating of the aluminium alloy strip has a degree of cross-linking of at least 20% to 80%, preferably 30% to 70%, more preferably 45% to 60%, wherein the degree of cross-linking is measured according to the “sol fraction test” referred to in the description and the aluminium alloy strip achieves an unchanged surface result of the coated side in a block test according to the description, wherein for the block test two blanks from the pre-product with their partially cross-linked, first coatings pointing in the same direction are placed on top of each other between two flat pressure bodies, the cut-outs laid on top of each other are pressed against each other over the pressure bodies with a pressure of at least 2.942 kPa and are heated and held for 24 hours in this state at 50° C. PMT, then the cut-outs are separated again and after the separation of the cut-outs the surface of the coating of the two cuts are examined for changes;
wherein
the pre-product is produced by coating an aluminium alloy strip with the at least one first coating, wherein the at least one first coating of the pre-product is cured in a first burn-in step up to a cross-linking degree of 20% to 80%, preferably 30% to 70%, more preferably 45% to 60%, wherein the pre-product achieves an unchanged surface result of the coated side in a block test according to the description and the at least one first coating of the pre-product is coated with at least one second coating and then the at least one first and the at least one second coating are cured in a second burn-in step.

15. Method according to claim 14,
wherein
the at least one first coating is cured at a burn-in temperature which is lower than the burn-in temperature of the second coating arranged on the first coating, wherein the at least one first coating is preferably partially cured at a burn-in temperature (PMT) of 180° C. to 240° C., preferably 200° C. to 230° C., particularly preferably 210° C. to 220° C., with a hold time of at least 1 to 20 seconds, preferably 2 to 12 seconds.

16. Method according to claim 14,
wherein
the pre-product is wound into a coil after the coating with the at least one first coating and partial curing of the at least one first coating.

17. Method according to claim 14,
wherein
after the coating with the at least one second coating, the at least one first coating and the at least one second coating are cured together in a second burn-in step with a burn-in temperature, wherein the burn-in temperature in the second burn-in step is higher than the burn-in temperature of the at least one first coating, wherein in the second burn-in step the curing preferably takes place at a PMT of 245° C. to 270° C., preferably 245° C. to 260° C., particularly preferably 248° C. to 255° C. with a holding time of 1 to 20 seconds, preferably 2 to 12 seconds and which at least one first coating and which at least one second coating are cured to a cross-linking degree of more than 90%, preferably more than 95%, particularly preferably more than 98%.
